(19) United States
(12) Patent Application Publication
(10) Pub. No.: US 2026/0089032 A1
(43) Pub. Date: Mar. 26, 2026

(54) APPARATUS AND METHOD FOR CHANNEL ESTIMATION USING DEMODULATION REFERENCE SIGNAL

(71) Applicant: ELECTRONICS AND TELECOMMUNICATIONS RESEARCH INSTITUTE, Daejeon (KR)

(72) Inventors: Eun-Sook JIN, Daejeon (KR); Hye-Yeon KWON, Daejeon (KR); Seung-Keun PARK, Daejeon (KR)

(73) Assignee: ELECTRONICS AND TELECOMMUNICATIONS RESEARCH INSTITUTE, Daejeon (KR)

(21) Appl. No.: 19/337,850

(22) Filed: Sep. 23, 2025

(30) Foreign Application Priority Data
Sep. 25, 2024 (KR) 10-2024-0129965
Sep. 8, 2025 (KR) 10-2025-0127351

(51) Int. Cl. H04L 25/02

(52) U.S. Cl. CPC H04L 25/0224; H04L 25/0256

(57) ABSTRACT

Disclosed herein is an apparatus and method for channel estimation using Demodulation Reference Signal (DMRS). The apparatus receives a DMRS, computes a Least Squares (LS) channel estimation value corresponding to the received DMRS, generates a time-domain channel response by performing an Inverse Discrete Fourier Transform (IDFT) on the LS channel estimation value, estimates noise components by setting bilateral noise windows within the time-domain channel response, removes noise components from the time-domain channel response by performing element-wise Minimum Mean Square Error (eMMSE) correction using the estimated noise components, and recovers a frequency-domain channel response by performing an N-point DFT on the corrected time-domain channel response.

### CROSS REFERENCE TO RELATED APPLICATIONS

This application claims the benefit of Korean Patent Applications No. 10-2024-0129965, filed Sep. 25, 2024, and No. 10-2025-0127351, filed Sep. 8, 2025, which are hereby incorporated by reference in their entireties into this application.

### BACKGROUND OF THE INVENTION

### 1. Technical Field

The present disclosure relates generally to technology for mobile communication systems, and more particularly to channel estimation technology using DRMS.

### 2. Description of the Related Art

Since the launch of 5G mobile communication services, the demand for mobile communication signal measurement has continued to increase. In particular, with the government-led introduction of e-Um 5G service, the method of using the same frequency by multiple operators has been adopted, unlike commercial networks in which frequencies between operators are separated, so not only the importance of inference management between operators but also the demand for measurement have increased.

Because measurement for interference management is mainly performed at cell boundaries, it is necessary to extract required information even in relatively low Signal-to-Interference-plus-Noise Ratio (SINR) environments. In order to improve reception performance in low SINR environments, it is necessary to enhance the accuracy of channel estimation. Among channel estimation methods introduced so far, the algorithm with the highest performance is a Minimum Mean Square Error (MMSE) method. Although this method provides high accuracy, it requires separate statistical information about the channel and has very high implementation complexity, so it is not commonly used. In particular, due to high demand for miniaturization of measurement devices and resource limitations, a channel estimation method capable of reducing implementation complexity while improving performance is required, rather than relying on the MMSE method.

When a channel is estimated using known information such as Demodulation Reference Signal (DMRS), the most common method is a Least Squares (LS) channel estimation method. This method removes known DMRS components from a received signal, but it cannot separate channel components from noise. Accordingly, when noise is large, performance is severely degraded. Therefore, it is used along with an algorithm capable of removing noise, and a method commonly used in CRS-based LTE systems is evaluated as the most efficient method because it has significantly low implementation complexity compared to the MMSE method and has improved performance compared to the LS method.

Channel estimation in a mobile communication system using an OFDM method uses a Reference Signal (RS), which is an appointed signal corresponding to a pilot. The Cell-specific Reference Signal (CRS) of LTE is periodically distributed across the entire communication band regardless of data transmission, whereas the DMRS of 5G systems is distributed only in the band where data is present at the time of data transmission.

As the DMRS distribution method in 5G systems has changed, a Discrete Fourier Transform (DFT) denoising method used in the existing LTE channel estimation method can no longer be applied. This is because the DFT denoising method is designed under the assumption of a full-band pilot, and analysis or application measures for cases where the DMRS exists only in the data transmission area as in 5G systems are not presented.

Accordingly, the low-complexity channel estimation method using DMRS in 5G systems is an LS+LI combination, as shown in FIG. 3, and the DFT denoising method cannot be applied, so performance degradation cannot be avoided.

Meanwhile, Korean Patent No. 10-2282868, titled “Method and apparatus for channel estimation in wireless communication system”, discloses an apparatus and method for channel estimation using a reference signal in a 5G or pre-5G communication system.

### SUMMARY OF THE INVENTION

An object of the present disclosure is to provide a channel estimation method capable of accurately recovering a Channel Impulse Response (CIR) using only limited frequency resources even under the constraint that Demodulation Reference Signal (DMRS) is not uniformly distributed over the entire band in an actual communication system.

Another object of the present disclosure is to improve the problem of degradation of time-domain resolution and noise amplification that occurs in an existing interpolation-based channel estimation method and to effectively recover channel characteristics even when only DMRS points are used.

A further object of the present disclosure is to minimize the phase repetition and distortion phenomenon of a CIR even in a limited bandwidth (BW) environment while securing both computational efficiency and ease of hardware implementation.

Yet another object of the present disclosure is to ensure both versatility and practicality by enabling the proposed structure to be applicable even in an actual communication environment in which DMRS is distributed only in a limited band, such as 5G NR.

In order to accomplish the above objects, an apparatus for channel estimation using Demodulation Reference Signal (DMRS) according to an embodiment of the present disclosure includes one or more processors and memory for storing at least one program executed by the one or more processors, and the at least one program receives a DMRS, computes a Least Squares (LS) channel estimation value corresponding to the received DMRS, generates a time-domain channel response by performing an Inverse Discrete Fourier Transform (IDFT) on the LS channel estimation value, estimates noise components by setting bilateral noise windows within the time-domain channel response, removes noise components from the time-domain channel response by performing element-wise Minimum Mean Square Error (eMMSE) correction using the estimated noise components, and recovers a frequency-domain channel response by performing an N-point DFT on the corrected time-domain channel response.

Here, the IDFT may be performed with a size corresponding to the number of DMRS points.

Here, the time-domain channel response may have a length less than an FFT size and may be aligned to the FFT size through zero padding after recovery.

Here, the at least one program may set a region other than positive and negative windows as a noise window based on a repetitive phase structure of the time-domain channel response, thereby estimating the noise components.

Here, the at least one program may estimate the noise components by using an average power value of samples within the noise window.

Here, the at least one program may perform the eMMSE correction by applying individual correction coefficients for each sample depending on a signal-to-noise ratio.

Here, the eMMSE correction may be performed by multiplying the correction coefficient that offsets an effect of noise power, in proportion to magnitude of a complex-domain channel estimation value of the received DMRS.

Here, the correction coefficient may be configured to increase as the magnitude of the complex-domain channel estimation value decreases.

Also, in order to accomplish the above objects, a method for channel estimation using DMRS, performed by an apparatus for channel estimation using DMRS, according to an embodiment of the present disclosure includes receiving a DMRS, computing a Least Squares (LS) channel estimation value corresponding to the received DMRS, generating a time-domain channel response by performing an Inverse Discrete Fourier Transform (IDFT) on the LS channel estimation value, estimating noise components by setting bilateral noise windows within the time-domain channel response, removing noise components from the time-domain channel response by performing element-wise Minimum Mean Square Error (eMMSE) correction using the estimated noise components, and recovering a frequency-domain channel response by performing an N-point DFT on the corrected time-domain channel response.

Here, the IDFT may be performed with a size corresponding to the number of DMRS points.

Here, the time-domain channel response may have a length less than an FFT size and may be aligned to the FFT size through zero padding after recovery.

Here, estimating the noise components may comprise setting a region other than positive and negative windows as a noise window based on a repetitive phase structure of the time-domain channel response, thereby estimating the noise components.

Here, estimating the noise components may comprise estimating the noise components by using an average power value of samples within the noise window.

Here, removing the noise components may comprise performing the eMMSE correction by applying individual correction coefficients for each sample depending on a signal-to-noise ratio.

Here, the eMMSE correction may be performed by multiplying the correction coefficient that offsets an effect of noise power, in proportion to magnitude of a complex-domain channel estimation value of the received DMRS.

Here, the correction coefficient may be configured to increase as the magnitude of the complex-domain channel estimation value decreases.

### BRIEF DESCRIPTION OF THE DRAWINGS

The above and other objects, features, and advantages of the present disclosure will be more clearly understood from the following detailed description taken in conjunction with the accompanying drawings, in which:

FIG. 1 is a view illustrating a CIR recovery capability analysis process according to an embodiment of the present disclosure;

FIG. 2 is a view illustrating the definition and characteristics of a matrix T_{dmrs} used for CIR recovery capability analysis according to an embodiment of the present disclosure;

FIG. 3 is a view illustrating the structure and recovery range of a CIR recovery matrix according to an embodiment of the present disclosure;

FIG. 4 is a view illustrating the configuration of a CIR recovery matrix depending on DMRS bandwidth (BW) according to an embodiment of the present disclosure;

FIG. 5 is a view illustrating a change in a CIR recovery matrix depending on the bandwidth (BW) and frequency location (BWP) of DMRS according to an embodiment of the present disclosure;

FIG. 6 is a graph illustrating component analysis of a CIR recovery matrix depending on DMRS bandwidth according to an embodiment of the present disclosure;

FIG. 7 is a view illustrating a channel estimation process using DMRS according to an embodiment of the present disclosure;

FIG. 8 is a view illustrating noise removal and eMMSE-based channel estimation processes after DMRS-based CIR recovery according to an embodiment of the present disclosure;

FIG. 9 is a view illustrating a window setting process according to an embodiment of the present disclosure;

FIG. 10 is a flowchart illustrating a method for channel estimation using DMRS according to an embodiment of the present disclosure;

FIG. 11 is a graph that compares channel estimation performance depending on an RB size according to an embodiment of the present disclosure; and

FIG. 12 is a view illustrating a computer system according to an embodiment of the present disclosure.

### DESCRIPTION OF THE PREFERRED EMBODIMENTS

The present disclosure will be described in detail below with reference to the accompanying drawings. Repeated descriptions and descriptions of known functions and configurations which have been deemed to unnecessarily obscure the gist of the present disclosure will be omitted below. The embodiments of the present disclosure are provided to fully describe the present disclosure to a person having ordinary knowledge in the art. Accordingly, the shapes, sizes, etc. of components in the drawings may be exaggerated in order to make the description clearer.

Throughout the specification, when a part “includes” a component, which means that it may further include other components, rather than excluding other components, unless otherwise specified.

Because the present disclosure may be variously changed and may have various embodiments, specific embodiments will be described in detail below with reference to the attached drawings.

However, it should be understood that those embodiments are not intended to limit the present disclosure to specific disclosure forms and that they include all changes, equivalents or modifications included in the spirit and scope of the present disclosure.

Various terms, such as “first”, “second”, “A”, “B”, “(a)”, “(b)”, etc., can be used to describe components of embodiments of the present disclosure. These terms merely differentiate one component from the other, but the substances, order, or sequence of the components are not limited by the terms.

Unless defined differently, all terms used herein, including technical or scientific terms, have the same meanings as terms generally understood by those skilled in the art to which the present disclosure pertains. Terms identical to those defined in generally used dictionaries should be interpreted as having meanings identical to contextual meanings of the related art, and are not to be interpreted as having ideal or excessively formal meanings unless they are definitively defined in the present specification.

In the present disclosure, it will be understood that when a component is referred to as being “connected” or “coupled” to another component, it can be directly connected or coupled to the other component, or intervening components may be present.

The terms used herein are for the purpose of describing particular embodiments only and are not intended to limit the present disclosure. As used herein, the singular forms are intended to include the plural forms as well, unless the context clearly indicates otherwise. It will be further understood that the terms “comprises,” “comprising,”, “includes” and/or “including,” when used herein, specify the presence of stated features, integers, steps, operations, components, or combinations thereof, but do not preclude the presence or addition of one or more other features, integers, steps, operations, components, or combinations thereof.

Hereinafter, preferred embodiments of the present disclosure will be described in detail with reference to the accompanying drawings. In the following description of the present disclosure, independent reference numerals are used for components that may be the same in the drawings, in order to facilitate an overall understanding.

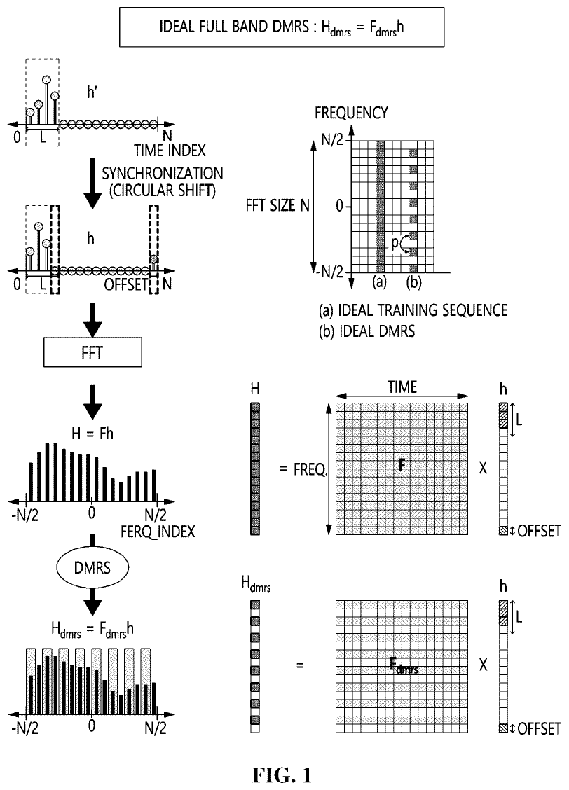

FIG. 1 is a view illustrating a CIR recovery capability analysis process according to an embodiment of the present disclosure.

Referring to FIG. 1, it can be seen that the relationship between H_{dmrs} and h (CIR) is illustrated for analyzing the CIR recovery capability. For analysis, it is assumed that DMRS is distributed over the entire band. Here, N denotes an FFT size, p denotes a DMRS period, L denotes a maximum channel delay time, and offset denotes a timing offset value that is extracted in the process in which h′ becomes h through a synchronization process. Here, p is assumed to be a divisor of N, and M=N/p.

Because information obtainable at a receiver is limited to channel information at DMRS points, it is necessary to redefine FFT and IFFT functions using this information. As shown in FIG. 1, H_{dmrs} (F_{dmrs}=H_{dmrs}h), which is an FFT matrix for DMRS, may be defined, and using this, an IFFT matrix that uses only DMRS point data may be obtained.

A synchronization circuit may recover a precisely time-aligned channel response, h, by circularly shifting the received signal h′, which includes a time delay or timing offset, back to its original reference position.

An FFT block performs an FFT operation on the time-domain channel response, h, thereby generating a frequency response, H.

A frequency transformation matrix, F, may transform the time-domain CIR, h, into the frequency-domain response, H, which may be modeled as a matrix product, H=Fh.

In the case of ideal full-band DMRS arrangement, a training sequence (a) and points of DMRS (b) are placed at equal intervals across the entire band, so uniform sampling may be performed over the entire frequency range.

The DMRS submatrix, F_{dmrs}, is formed by extracting only rows corresponding to the DMRS points from the entire FFT matrix, F, and through this matrix, a DMRS-based channel response may be computed in the form of H_{dmrs}=F_{dmrs}h.

As a result, the DMRS-based frequency response, H_{dmrs}, may be computed as the product of the time-domain CIR, h, and the DMRS sub-FFT matrix, F_{dmrs}.

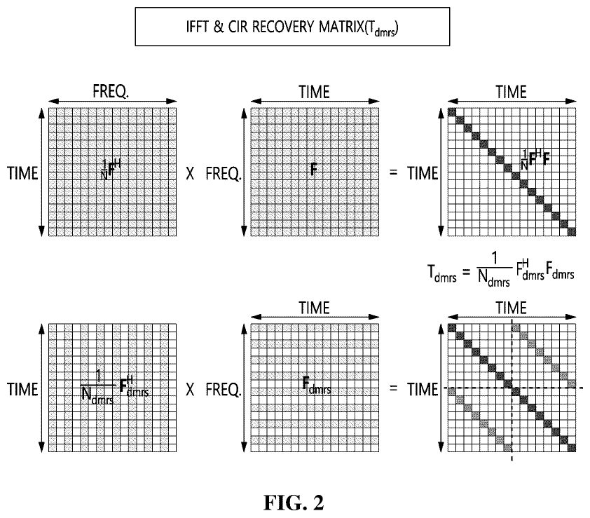

FIG. 2 is a view illustrating the definition and characteristics of a matrix T_{dmrs} that is used to analyze the CIR recovery capability according to an embodiment of the present disclosure.

Referring to FIG. 2, T_{dmrs} is a matrix obtained by multiplying FFT and IFFT matrices after defining these matrices using only DMRS point data, and it can be seen that, unlike an identity matrix I, elements at which j≠i, mod(j−1, M)=0 are satisfied have values, as shown in Equation (1) below:

$${T}_{d m r s} = \frac{1}{{N}_{d m r s}} {F}_{d m r s}^{H} {F}_{d m r s} {∈}^{N \times N} \qquad ( 1 )$$

$${T}_{d m r s} ( i , j ) = \frac{1}{M} {\sum }_{k = 0}^{M - 1} {F}_{d m r s}^{H} ( i , k ) {F}_{d m r s} ( k , j ) = \frac{1}{M} {ω}_{N}^{( {p}_{0} - N / 2 ) ( j - i )} {\sum }_{k = 0}^{M - 1} {ω}_{M}^{k ( j - i )}$$

$$= \{ \begin{matrix}1 , & j = i \\ {ω}_{N}^{( {p}_{0} - N / 2 ) ( j - i )} , & \begin{matrix}j \neq i , mod ( j - i , M ) = 0 , i = \\ 0 , … , N - 1 , j = 0 , … , N - 1\end{matrix} \\ 0 & j \neq i , mod ( j - i , M ) \neq 0\end{matrix}$$

The entire IFFT matrix,

$$\frac{1}{N} {F}^{H} ,$$

may perform an IFFT operation for transforming information of the entire frequency domain into the time domain.

The entire FFT matrix, F, may represent an FFT operation for transforming the time-domain channel response into the frequency domain.

The product of these matrices may converge to an identity matrix, which may mathematically represent that complete frequency-time transformation is possible.

When only the DMRS is used in an actual system, a partial IFFT matrix

$$\frac{1}{{N}_{d m r s}} {F}_{d m r s}^{H}$$

may perform a time-domain transformation operation limited to DMRS points.

The partial FFT matrix F_{dmrs} may be formed by extracting only the frequency components corresponding to the DMRS points from the entire FFT matrix.

The product of these two matrices

$${T}_{d m r s} = \frac{1}{{N}_{d m r s}} {F}_{d m r s}^{H} {F}_{d m r s} ,$$

may define a recovery matrix that recovers the time-domain channel response using only the limited DMRS points.

Unlike an identity matrix, the resulting matrix T_{dmrs} does not have a perfectly diagonal structure but may have a structure including sidelobes on both sides of the main diagonal.

Such a matrix structure may visually explain that distortion may occur in the recovered channel impulse response when the DMRS is not uniformly distributed over the entire band.

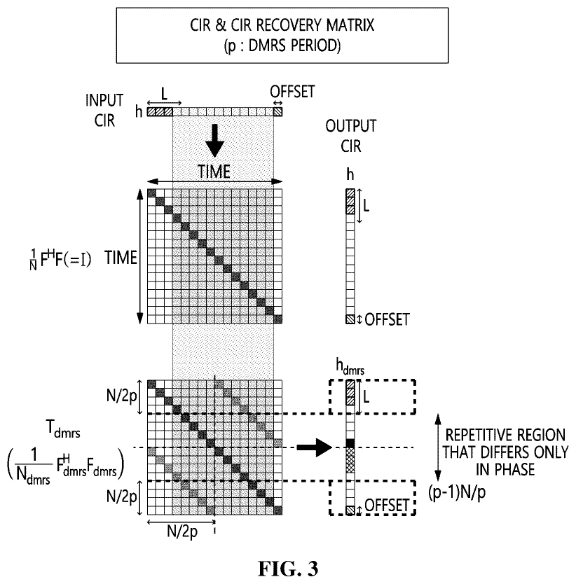

FIG. 3 is a view illustrating the structure and recovery range of a CIR recovery matrix according to an embodiment of the present disclosure.

Referring to FIG. 3, when T_{dmrs} is used, the output form of the input CIR, h, can be seen. As shown in FIG. 3, when the CIR is recovered through an IFFT using only the DMRS point data, a repetitive region that differs only in phase occurs, which limits a valid region. Here, the valid region may be identified based on the values of N and p.

Based on the result of FIG. 3, it can be confirmed that, when M=N/p, M is an integer, and the DMRS is distributed over the entire FFT band, perfect CIR recovery is possible even though only the DMRS point data is used.

The input CIR, h, is the time-domain channel response configured with the maximum delay time L and a timing offset, and may be input to FFT and IFFT operations.

The product of the entire IFFT and FFT matrices is an identity matrix, and the time-domain CIR may be recovered without distortion.

The output CIR, h, is completely recovered with the same structure as the input, and it may represent that error-free time-frequency transformation is possible.

When only DMRS points are used in an actual system, the recovery matrix,

$${T}_{d m r s} = \frac{1}{{N}_{d m r s}} {F}_{d m r s}^{H} {F}_{d m r s} ,$$

is an IFFT-based recovery matrix configured with limited frequency resources, and it may have a structure spread around the diagonal, rather than a perfect identity matrix.

The recovered CIR, h_{dmrs}, may accurately recover a valid signal region, but outside the valid signal region, it may have a repetitive structure that differs only in phase.

The size of the repetitive region,

$$( p - 1 ) \frac{N}{p} ,$$

corresponds to the region in which the same structure is replicated outside the recoverable region, which may limit the effective CIR recovery performance in practice.

The valid recovery length

$$\frac{N}{2 p}$$

is a reliable region when only the DMRS points are used, and accurate CIR analysis may be possible only within this range.

However, in an actual system, the DMRS cannot be distributed across the entire FFT band, and guard bands exist on both sides of the signal band (BW).

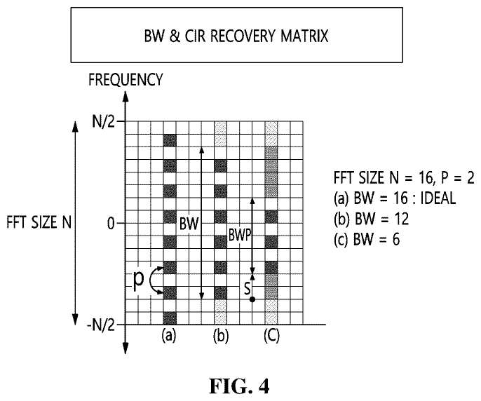

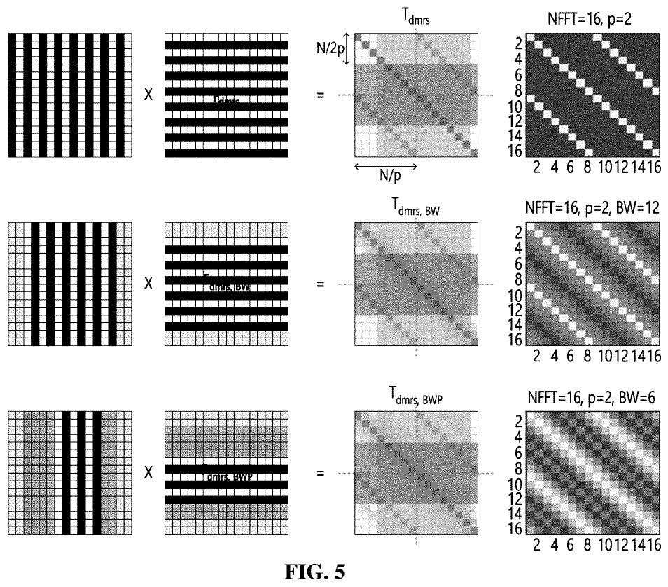

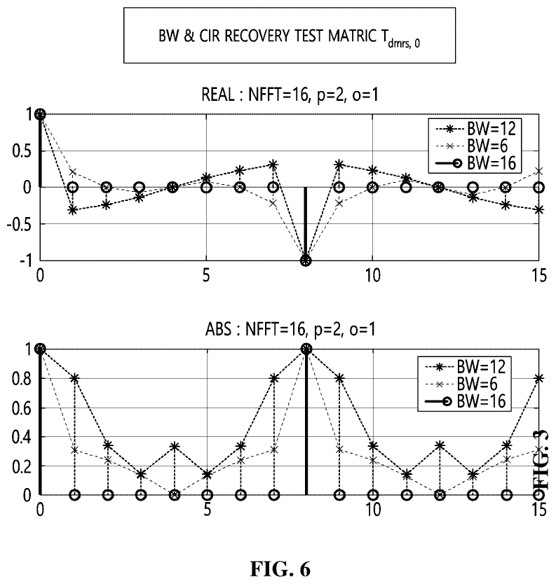

FIG. 4 is a view illustrating the configuration of a CIR recovery matrix depending on DMRS bandwidth (BW) according to an embodiment of the present disclosure. FIG. 5 is a view illustrating changes in a CIR recovery matrix depending on the bandwidth (BW) and frequency location (BWP) of DMRS according to an embodiment of the present disclosure. FIG. 6 is a graph illustrating component analysis of a CIR recovery matrix depending on DMRS bandwidth according to an embodiment of the present disclosure.

Referring to FIGS. 4 and 5, it can be seen that the distribution of the matrix T_{dmrs} and the values of the first column (T_{dmrs,0}) of the matrix T_{dmrs} are illustrated depending on the DMRS distribution.

In FIG. 4, the vertical axis may represent the distribution over the entire frequency domain based on the FFT size, N.

The range from −N/2 to +N/2 may correspond to the FFT bin index.

Along the horizontal direction, (a), (b), and (c) are examples distinguished by different DMRS bandwidth (BW) conditions, and they may indicate the following.
(a) corresponds to an ideal full-band DMRS allocation (BW=16).
(b) corresponds to limited bandwidth (BW=12, LTE level).
(c) corresponds to further reduced bandwidth (BW=6, an example of 5G NR BWP).

BW denotes the total amount of available frequency resources and may indicate the size of the band in which the DMRS is allocated.

BWP refers to a Bandwidth Part, which is a sub-band actually used by the system, and may visually indicate that the center location of the DMRS may shift.

The DMRS period p may indicate that the DMRS is repeatedly placed at equal intervals along the frequency axis, and it may be used as a key factor related to the periodicity of a recovery matrix.

The circular arrow represents a circularly repeated structure in units of subcarrier spacing or FFT bins, which may explain that the recovery performance may be limited by the repeatability and periodicity.

In conclusion, how the reduction of DMRS bandwidth (BW) and the shift of the location (BWP) of the DMRS affect the configuration and performance of the channel impulse response (CIR) recovery matrix may be visually compared.

FIG. 5 visually compares the structural difference of the CIR recovery matrix T_{dmrs} that is formed depending on the distribution characteristics of DMRS points within the frequency domain, thereby explaining the effects of the DMRS bandwidth (BW) and the central location (BWP) on the accuracy of CIR recovery.

In FIG. 5, the partial structures of FFT and IFFT matrices used in each environment are presented. In the ideal full-band environment, all rows and columns of the FFT and IFFT matrices are used, and this makes the condition under which a recovery matrix maintains an ideal identity matrix form. Accordingly, T_{dmrs} shown in the first row exhibits distinct main diagonal components, but the off-diagonal components have values close to zero. This indicates that the CIR can be accurately recovered in the ideal environment.

In contrast, when the DMRS bandwidth is limited (e.g., BW=12), only part of the columns or rows of the FFT/IFFT matrices is used, so the recovery matrix includes sidelobes gradually spreading beyond the main diagonal. As a result, the recovered CIR contains increased distorted components compared to the ideal case, and its structure becomes more susceptible to noise.

Also, the configuration with BW=6 represents the case in which the DMRS is biased toward a specific bandwidth part (BWP). In this case, the rows and columns of the FFT matrix to be used are asymmetrically selected, and as a result, the recovery matrix also exhibits an asymmetrical structure, which may cause not only phase distortion but also positional imbalance in the recovered components.

In the configuration with BW=16, a graph that visualizes each recovery matrix based on color is presented together. In the configuration of BW=16, a clear diagonal is formed, but as the bandwidth is reduced to BW=12 and BW=6, the sidelobes become increasingly prominent and diagonal components are spread. This visually represents that the dispersion of DMRS increases and that the recovery accuracy decreases.

In summary, FIG. 5 visually represents that ideal CIR recovery is possible when DMRS points that are uniformly distributed across the entire band are used, but in actual communication systems, structural distortion of a recovery matrix may be inevitably caused due to the limited DMRS bandwidth and the shift of the location thereof. Therefore, in order to overcome such structural limitations, the necessity of correction techniques (e.g., eMMSE, windowing, etc.) is emphasized.

FIG. 6 is a graph that visually represents the distribution of the components of the first column of the recovery matrix T_{dmrs}, that is, the components corresponding to T_{dmrs,0}. Accordingly, a change in the accuracy of CIR recovery based on the DMRS bandwidth (BW) may be quantitatively analyzed.

The upper graph (Real Component) illustrates the values of real components, and the lower graph (Absolute Value Component) illustrates the values of absolute value (abs) components. The respective graphs correspond to a test performed under the conditions in which the FFT size, the DMRS period, and the timing offset are set to N=16, p=2, and o=1, respectively, and they include comparisons for three cases in which the bandwidth (BW) is 16, 12, and 6.

In the upper graph (Real Component), which is a graph for real components, when BW=16, central components close to 1 or −1 are present at the diagonal positions (index 0 and 8), while the other elements converge nearly to zero. This indicates an ideal recovery matrix close to an identity matrix.

However, when the DMRS bandwidth is reduced to BW=12 and BW=6, nonzero values appear not only at the central components but also at multiple positions around the central components, and sidelobes increase. This indicates that distortion may be introduced into the recovered CIR.

The same tendency is observed in the lower graph (Absolute Value Component), which is a graph based on absolute values. In the case of BW=16, the central component is 1, and the other components completely converge to zero. However, when BW=12 and BW=6, the values of surrounding components increase to the level of 0.2-0.6, which indicates dispersion of recovery errors across a wide region.

Particularly, in the case of BW=6, the sidelobe components appear more prominently than when BW=12, and this indicates that CIR recovery becomes sensitive to noise rather than the signal in environments in which DMRS resources are insufficient.

When the DMRS distribution is the same as in LTE (BW=12) or in 5G (BW=6), perfect CIR recovery is impossible, but as shown in FIG. 6, a CIR estimation value in the form of a CIR multiplied by a Sinc function may be obtained, and it can be seen that there is a characteristic that an error decreases as the BW size increases.

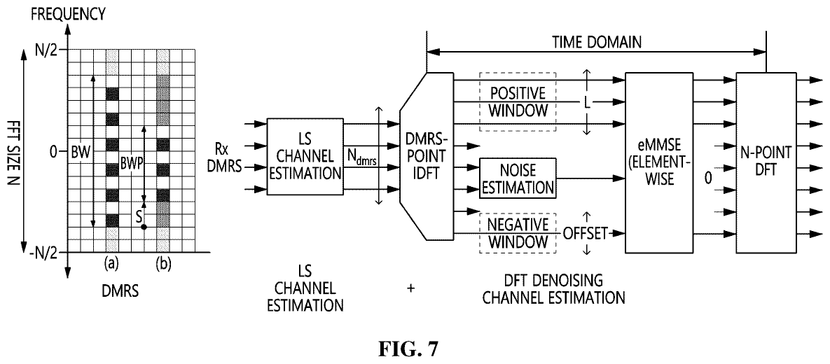

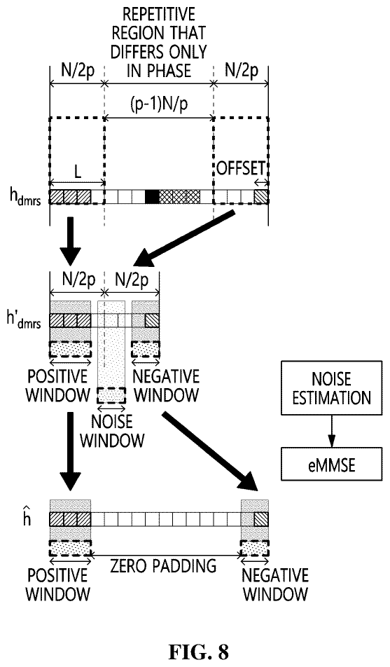

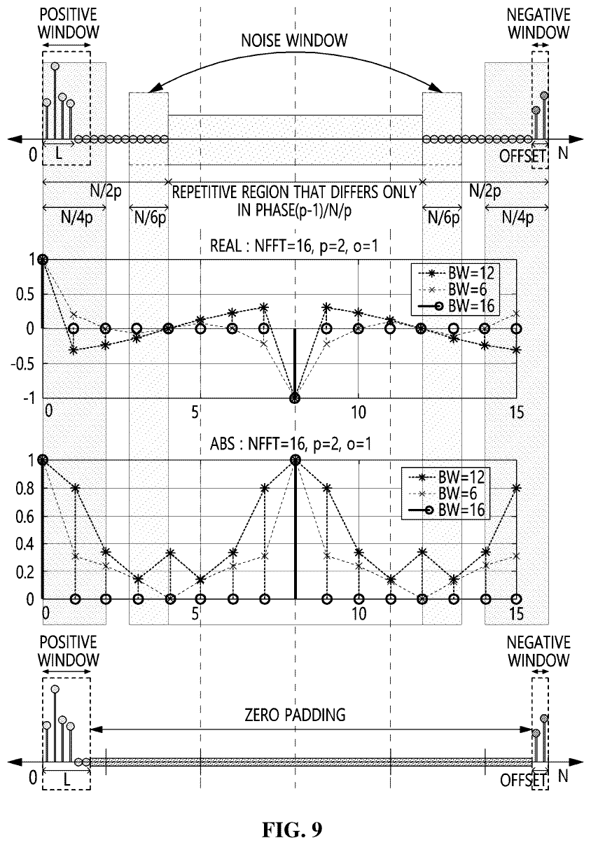

FIG. 7 is a view illustrating a channel estimation process using DMRS according to an embodiment of the present disclosure. FIG. 8 is a view illustrating noise removal and eMMSE-based channel estimation processes after DMRS-based CIR recovery according to an embodiment of the present disclosure. FIG. 9 is a view illustrating a window setting process according to an embodiment of the present disclosure.

Referring to FIG. 7, it can be seen that CIR recovery is possible without using interpolation methods used in existing techniques by applying a DFT using only channel values at DMRS points.

It can be seen that, after a channel impulse response (CIR) is recovered using a received DMRS (Rx DMRS), the process of improving channel estimation accuracy by applying a DFT-based denoising technique is illustrated.

In the distribution of DMRS points over the frequency domain, (a) represents an ideal situation in which the DMRS is uniformly distributed across the entire band, and (b) represents a realistic situation in which the DMRS is concentrated within a specific Bandwidth Part (BWP). Such an environment affects the performance of subsequent channel recovery and denoising algorithms.

First, the received DMRS (Rx DMRS) passes through a Least Squares (LS) channel estimation block, and complex channel coefficients of each DMRS subcarrier are estimated. Here, the number of DMRS points used is defined as N_{dmrs}.

Subsequently, the estimated frequency-domain channel value may be transformed into an initial CIR of the time domain through an inverse DFT (IDFT) operation based on the DMRS points. The corresponding CIR may be corrected to obtain a final channel estimate by removing noise therefrom in subsequent steps.

Subsequently, the time-domain CIR may be processed by being divided into a positive window, a negative window, and a noise window.

The positive window corresponds to a region in which it is highly likely that a valid channel response exists within the maximum delay time L. The negative window corresponds to a region in which a timing offset is considered.

The noise window corresponds to a region assumed to contain no valid channel response, and noise power may be estimated through the average of power in this region.

The result of estimation of the noise power is input to an element-wise Minimum Mean Square Error (eMMSE) filter corresponding to the subsequent step, and the channel response values present in the positive and negative window regions may be precisely corrected on a per-sample basis.

Subsequently, the region other than the valid window regions are padded with zeros, and an N-point DFT is performed again on the entire CIR, whereby the frequency-domain channel response may be finally obtained.

As a result, unlike the existing LS-based channel estimation method, the present disclosure enables more accurate and stable channel estimation results to be obtained by utilizing the structural repetition characteristics of the recovered CIR and the precise correction technique (eMMSE) using a noise region.

FIG. 8 illustrates the overall process in which a valid signal region and a noise region are separated based on a time-domain channel impulse response h_{dmrs} recovered using only DMRS points and then a final channel response ĥ is computed through noise removal and precise correction.

Here, h_{dmrs} is the time-domain channel response that is recovered through an IFFT based on the DMRS points only in a partial frequency domain.

Structurally, h_{dmrs} has the same pattern repeated at intervals of N/p, where the actual valid information exists only within the central region of N/2p and the remaining region has a structure repeated with only phase differences. This repeated region has a total length of (p−1)N/p, and it may be referred to as “repetitive region that differs only in phase”.

Based on the repetitive structure, h_{dmrs} may be divided into a noise window in which no signal exists and two windows in which valid signals are included (positive and negative windows).

The positive window is a valid region located earlier based on the maximum channel delay time L, and the negative window is a valid signal region located later, which accounts for the timing offset.

The noise window located between the positive and negative windows contains no signal components due to the repetitive structure and may be used for estimating the average noise power.

Subsequently, the extracted windows are arranged to form h′_{dmrs}, and noise power may be estimated based on the average power measured in the noise window. The noise estimate is used for element-wise Minimum Mean Square Error (eMMSE) method, whereby correction may be performed on each sample within the positive and negative windows by applying the SNR-based optimal weight thereto.

The corrected signal region is maintained, the region including noise is filled with zeros (zero padding), and the resulting signal may become the finally recovered time-domain channel response ĥ.

Unlike the existing interpolation-based channel estimation method, this structure enables high-precision correction by identifying a valid region using the repetitive structure of a partial CIR recovered using only DMRS points and quantitatively estimating noise power, so it has technical advantages. Particularly, this structure is capable of reducing computational complexity while minimizing the effect of noise, so practical channel estimation performance may be ensured in actual system environments.

However, as shown in FIG. 9, it is necessary to determine the length of the positive window in consideration of the maximum delay time of the channel in the valid region of the extracted h_{dmrs}, to determine the length of the negative window in consideration of the maximum timing offset value, to determine the location of the noise window in which noise power can be estimated outside the maximum delay time, and to extract signal components based on the determination results.

Referring to FIG. 9, the processes of analyzing distortion characteristics that occur according to the repetitive structure of a signal configuration and the bandwidth variation and correcting the distortion characteristics to improve performance of channel impulse response (CIR) recovery are explained step by step.

Based on the configuration of the recovered CIR signal in the upper area, it can be seen that a structure in which the same pattern is repeated with only phase differences is present, excluding some regions in which a signal is included. Because the region with the repetitive structure is highly likely to correspond to distorted noise components, rather than actual channel information, it is possible to estimate and remove noise based thereon.

Through the graphs (REAL, ABS) in the middle, recovery results obtained under an ideal recovery condition and under a limited bandwidth condition may be compared. As the bandwidth increases, the accuracy of the recovery matrix increases, but as the bandwidth decreases, the surrounding components grow, which makes accurate recovery more difficult. Accordingly, a change in recovery accuracy depending on the bandwidth condition of the system may be identified.

In the lower area, a finally corrected CIR may be generated by maintaining only reliable regions and removing the other region based on the analyzed repetitive structure and the window configuration. Particularly, the leading and trailing regions in which a valid signal exists are identified as positive and negative windows, and the other repetitive region is padded with zeros (zero padding), whereby noise may be minimized.

Also, average noise power is separately estimated by extracting only the repetitive noise region, and least-squares-based correction is applied based thereon, whereby the actual signal may be more precisely recovered. This method may enhance the noise removal effect and improve the computational efficiency of the system.

In conclusion, this structure may ensure CIR recovery accuracy even under bandwidth-limited conditions and implement a receiver robust against noise.

When a CIR is estimated by applying element-wise MMSE (eMMSE) for each sample only within the valid signal region using the estimated noise power value and when all the other values are set to zero to obtain an FFT, a channel estimation value from which noise is removed may be obtained.

$$\hat{h} ( k ) = \tilde{h} ( k ) [ 1 + \frac{{σ}_{n}^{2}}{{\vert \tilde{h} ( k ) \vert}^{2}} ] \qquad ( 2 )$$

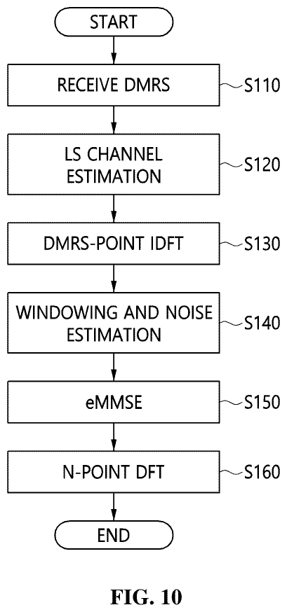

FIG. 10 is a flowchart illustrating a method for channel estimation using DMRS according to an embodiment of the present disclosure.

Referring to FIG. 10, a DMRS may be received at step S110.

That is, at step S110, a Demodulation Reference Signal (DMRS) transmitted from a transmitter may be received.

Here, the DMRS is mapped to a specific subcarrier on a frequency domain, and it may be used as a reference signal for subsequent channel estimation.

Also, at step S120, LS channel estimation may be performed based on the received DMRS.

That is, at step S120, channel response estimation may be performed by applying a Least Squares (LS) method using the received DMRS.

Here, at step S120, channel response estimation is performed for a subcarrier region in which the DMRS is present, and a result thereof may be used as an initial channel estimation value.

Also, at step S130, an IDFT corresponding to the DMRS subcarrier size may be performed on the LS estimation value.

That is, at step S130, an Inverse Discrete Fourier Transform (IDFT) may be performed with a size corresponding to the DMRS points in order to transform the LS estimation value of the frequency domain into a time domain.

Here, at step S130, the Inverse Discrete Fourier Transform (IDFT) is performed on the LS channel estimation value, whereby a time-domain channel response may be generated.

Here, the IDFT may be performed with a size corresponding to the number of DMRS points.

Here, the time-domain channel response has a length less than an FFT size, and after recovery thereof, it may be aligned to the FFT size through zero padding.

Here, the generated time-domain response may be used for subsequent noise estimation and correction processes.

Also, at step S140, a noise region based on a window may be extracted and estimated for the time-domain response.

That is, at step S140, bilateral noise windows may be set within the time-domain channel response, whereby noise components may be estimated.

Here, at step S140, the noise region may be defined based on positive and negative windows located on both sides of a valid channel region within the time-domain response.

Here, at step S140, based on the repetitive phase structure of the time-domain channel response, a region other than the positive and negative windows is set as a noise window, whereby the noise components may be estimated.

Here, at step S140, the noise components may be estimated using the average power value of samples within the noise window.

Accordingly, the average noise in each window is computed, and noise statistics to be used for correction may be estimated.

Also, at step S150, correction based on an eMMSE method may be performed based on the noise estimation value.

That is, at step S150, element-wise Minimum Mean Square Error (eMMSE) correction is performed using the noise components, whereby the noise components may be removed from the time-domain channel response.

Here, at step S150, in order to minimize noise included in the time-domain response by using the noise components, element-wise Minimum Mean Square Error (eMMSE) correction may be performed.

Here, at step S150, the eMMSE correction may be performed by applying individual correction coefficients for each sample depending on a signal-to-noise ratio.

Here, the eMMSE correction may be performed by multiplying the correction coefficient that offsets the effect of noise power, in proportion to the magnitude of the complex-domain channel estimation value of the received DMRS, as shown in Equation (2).

Here, the correction coefficient may be configured to increase as the magnitude of the complex-domain channel estimation value decreases.

Through this correction process, a channel response that is more precise than the initial LS estimate may be derived.

Also, at step S160, the full-size DFT is performed on the corrected time-domain response, whereby a frequency-domain response may be recovered.

That is, at step S160, after the time-domain channel response corrected through eMMSE is zero-padded to match the entire FFT size, an N-point DFT is performed, whereby the channel response across the entire frequency band may be recovered.

The corresponding result may be used in subsequent data symbol demodulation and channel equalization processes.

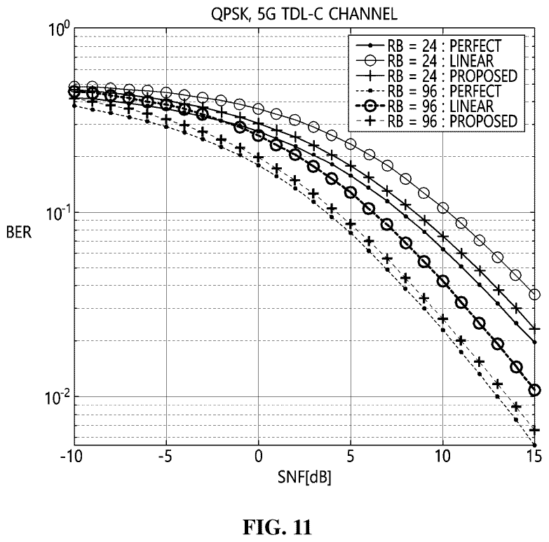

FIG. 11 is a graph that compares the channel estimation performance depending on the RB size according to an embodiment of the present disclosure.

Referring to FIG. 11, channel estimation performance depending on the RB size is compared, and it can be confirmed that the method proposed in the present disclosure has better performance compared to the existing LS+LI method and that the performance is very close to the performance that is achieved when channel information is known.

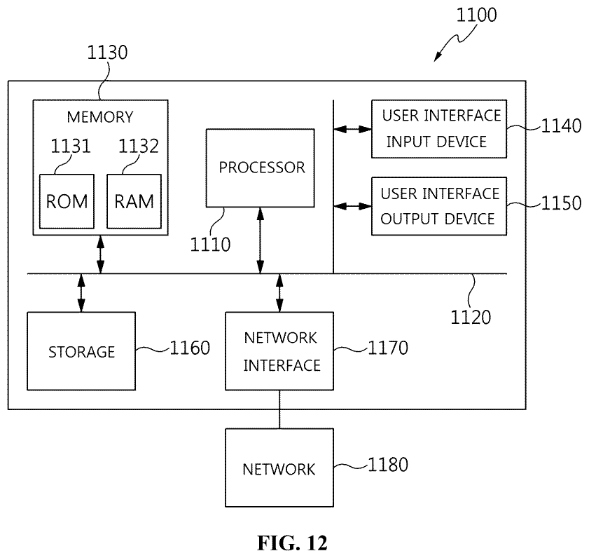

FIG. 12 is a view illustrating a computer system according to an embodiment of the present disclosure.

Referring to FIG. 12, the apparatus for channel estimation using DMRS according to an embodiment of the present disclosure may be implemented in a computer system 1100 including a computer-readable recording medium. As illustrated in FIG. 12, the computer system 1100 may include one or more processors 1110, memory 1130, a user-interface input device 1140, a user-interface output device 1150, and storage 1160, which communicate with each other via a bus 1120. Also, the computer system 1100 may further include a network interface 1170 connected to a network 1180. The processor 1110 may be a central processing unit or a semiconductor device for executing processing instructions stored in the memory 1130 or the storage 1160. The memory 1130 and the storage 1160 may be any of various types of volatile or nonvolatile storage media. For example, the memory may include ROM 1131 or RAM 1132.

Also, the apparatus for channel estimation using DMRS according to an embodiment of the present disclosure includes one or more processors 1110 and memory 1130 for storing at least one program executed by the one or more processors 1110, and the at least one program receives a Demodulation Reference Signal (DMRS), computes a Least Squares (LS) channel estimation value corresponding to the received DMRS, generates a time-domain channel response by performing an Inverse Discrete Fourier Transform (IDFT) on the LS channel estimation value, estimates noise components by setting bilateral noise windows within the time-domain channel response, removes noise components from the time-domain channel response by performing element-wise Minimum Mean Square Error (eMMSE) correction using the estimated noise components, and recovers a frequency-domain channel response by performing an N-point DFT on the corrected time-domain channel response.

Here, the IDFT may be performed with a size corresponding to the number of DMRS points.

Here, the time-domain channel response may have a length less than an FFT size, and may be aligned to the FFT size through zero padding after recovery.

Here, the at least one program may estimate the noise components by setting a region other than positive and negative windows as a noise window based on a repetitive phase structure of the time-domain channel response.

Here, the at least one program may estimate the noise components by using an average power value of samples within the noise window.

Here, the at least one program may perform the eMMSE correction by applying individual correction coefficients for each sample depending on a signal-to-noise ratio.

Here, the eMMSE correction may be performed by multiplying the correction coefficients that offset the effect of noise power, in proportion to the magnitude of a complex-domain channel estimation value of the received DMRS.

Here, the correction coefficient may be configured to increase as the magnitude of the complex-domain channel estimation value decreases.

The present disclosure may provide a channel estimation method capable of accurately recovering a Channel Impulse Response (CIR) using only limited frequency resources even under the constraint that Demodulation Reference Signal (DMRS) is not uniformly distributed over the entire band in an actual communication system.

Also, the present disclosure may improve the problem of degradation of time-domain resolution and noise amplification that occurs in an existing interpolation-based channel estimation method and may effectively recover channel characteristics even when only DMRS points are used.

Also, the present disclosure may minimize the phase repetition and distortion phenomenon of a CIR even in a limited bandwidth (BW) environment while securing both computational efficiency and ease of hardware implementation.

Also, the present disclosure may ensure both versatility and practicality by enabling the proposed structure to be applicable even in an actual communication environment in which DMRS is distributed only in a limited band, such as 5G NR.

As described above, the apparatus and method for channel estimation using DMRS according to the present disclosure are not limitedly applied to the configurations and operations of the above-described embodiments, but all or some of the embodiments may be selectively combined and configured, so the embodiments may be modified in various ways.

What is claimed is:

1. An apparatus for channel estimation using Demodulation Reference Signal (DMRS), comprising:
one or more processors; and
memory for storing at least one program executed by the one or more processors,
wherein the at least one program
receives a DMRS,
computes a Least Squares (LS) channel estimation value corresponding to the received DMRS,
generates a time-domain channel response by performing an Inverse Discrete Fourier Transform (IDFT) on the LS channel estimation value,
estimates noise components by setting bilateral noise windows within the time-domain channel response,
removes noise components from the time-domain channel response by performing element-wise Minimum Mean Square Error (eMMSE) correction using the estimated noise components, and
recovers a frequency-domain channel response by performing an N-point DFT on the corrected time-domain channel response.

2. The apparatus of claim 1, wherein the IDFT is performed with a size corresponding to a number of DMRS points.

3. The apparatus of claim 1, wherein the time-domain channel response has a length less than an FFT size and is aligned to the FFT size through zero padding after recovery.

4. The apparatus of claim 1, wherein the at least one program sets a region other than positive and negative windows as a noise window based on a repetitive phase structure of the time-domain channel response, thereby estimating the noise components.

5. The apparatus of claim 4, wherein the at least one program estimates the noise components by using an average power value of samples within the noise window.

6. The apparatus of claim 1, wherein the at least one program performs the eMMSE correction by applying individual correction coefficients for each sample depending on a signal-to-noise ratio.

7. The apparatus of claim 6, wherein the eMMSE correction is performed by multiplying the correction coefficient that offsets an effect of noise power, in proportion to magnitude of a complex-domain channel estimation value of the received DMRS.

8. The apparatus of claim 7, wherein the correction coefficient is configured to increase as the magnitude of the complex-domain channel estimation value decreases.

9. A method for channel estimation using Demodulation Reference Signal (DMRS), performed by an apparatus for channel estimation using DMRS, comprising:
receiving a DMRS;
computing a Least Squares (LS) channel estimation value corresponding to the received DMRS;
generating a time-domain channel response by performing an Inverse Discrete Fourier Transform (IDFT) on the LS channel estimation value;
estimating noise components by setting bilateral noise windows within the time-domain channel response;
removing noise components from the time-domain channel response by performing element-wise Minimum Mean Square Error (eMMSE) correction using the estimated noise components; and
recovering a frequency-domain channel response by performing an N-point DFT on the corrected time-domain channel response.

10. The method of claim 9, wherein the IDFT is performed with a size corresponding to a number of DMRS points.

11. The method of claim 9, wherein the time-domain channel response has a length less than an FFT size and is aligned to the FFT size through zero padding after recovery.

12. The method of claim 9, wherein estimating the noise components comprises setting a region other than positive and negative windows as a noise window based on a repetitive phase structure of the time-domain channel response, thereby estimating the noise components.

13. The method of claim 12, wherein estimating the noise components comprises estimating the noise components by using an average power value of samples within the noise window.

14. The method of claim 9, wherein removing the noise components comprises performing the eMMSE correction by applying individual correction coefficients for each sample depending on a signal-to-noise ratio.

15. The method of claim 14, wherein the eMMSE correction is performed by multiplying the correction coefficient that offsets an effect of noise power, in proportion to magnitude of a complex-domain channel estimation value of the received DMRS.

16. The method of claim 15, wherein the correction coefficient is configured to increase as the magnitude of the complex-domain channel estimation value decreases.
